(19) United States
(12) Patent Application Publication
(10) Pub. No.: US 2023/0338974 A1
(43) Pub. Date: Oct. 26, 2023

(54) SYSTEM AND APPARATUS FOR APPLYING BABBITT MATERIALS AND THE LIKE

(71) Applicants: HELMUT P. HOELL, RAPID CITY, SD (US); AARON T. NARDI, EAST GRANBY, CT (US); CHRISTOPHER D. HOWE, FARGO, ND (US)

(72) Inventors: HELMUT P. HOELL, RAPID CITY, SD (US); AARON T. NARDI, EAST GRANBY, CT (US); CHRISTOPHER D. HOWE, FARGO, ND (US)

(21) Appl. No.: 18/191,209

(22) Filed: Mar. 28, 2023

Related U.S. Application Data
(60) Provisional application No. 63/333,618, filed on Apr. 22, 2022.

(51) Int. Cl. B05B 7/14; B05B 1/02

(52) U.S. Cl. CPC B05B 7/1486; B05B 1/02

(57) ABSTRACT

A powder spray applicator system may include an applicator device configured to eject particles of powder in a stream of a heated gas. The applicator device defining a particle path along which particles of the powder stream move upon introduction into a flow chamber and a gas path along which a primary gas stream moves upon introduction into the flow chamber. The applicator device may include a body assembly defining an outer annular gap forming a first section of the gas path and an inner annular gap forming a second section of the gas path, and a spray nozzle defining a flow passage extending between an entry opening of the spray nozzle and an exit opening of the spray nozzle. The flow passage may have an initial section with a converging shape and a final section with a straight shape.

### REFERENCE TO RELATED APPLICATIONS

This application claims the priority benefit of U.S. Provisional Patent Application No. 63/333,618 filed Apr. 22, 2022, which is hereby incorporated by reference in its entirety.

### BACKGROUND

### Field

The present disclosure relates to material application on parts, and more particularly pertains to a new system and apparatus for applying Babbitt materials and the like which may facilitate the application in confined or small spaces.

### Description of the Prior Art

Many metallic surfaces are subject to damage due to all manner of relative sliding between the two mating surfaces. The damage can take the form of galling and seizure, severe adhesive wear, or even light adhesive wear depending on the materials in contact and the loads and relative sliding speed. In many of the mechanical systems where sliding contact occurs, friction can also play an important role both for reduction in load transferred, but also in heat generated which can have a profound impact on the sliding surfaces.

While lubrication of the mating surfaces can often provide a solution to many sliding wear and friction problems, the chemical compatibility with the material forming the surfaces can play an important role in minimizing the problems. Similarly, modifying the surface of a part to add a low shear strength material is known in adhesive friction theory to reduce the friction between two contacting surfaces. For utilizing both of these approaches, a class of materials known as Babbitt materials was developed for forming at least one of the contacting surfaces. These Babbitt materials originally often contained lead, but today Babbitt materials are often lead-free and contain significant amounts of tin.

Babbitt materials are commonly used in both lubricated and non-lubricated systems to protect against contact between critical metal surfaces, such as incidental contact occurring during startup and shutdown of a system. For example, Babbitt materials are used in the automotive industry for forming hydrodynamic bearing surfaces such as the bearings of connecting rod ends. Similarly, Babbitt materials are used in aircraft propeller systems to protect the shaft surfaces of the hydrodynamic bearings of the engine and propeller through which hydraulic flow is transferred. The hydrodynamic flow of the hydrodynamic bearing, however, is only created once the system is up to a fraction of the normal operating speed, and below a particular speed, there is typically incidental contact between the metallic surfaces of the bearing. The Babbitt materials protect these surfaces during the incidental contact that occurs prior to the system obtaining sufficient operating speed.

Babbitt materials are often applied using a spun-Babbitt process which relies on centrifugal forces to accelerate the molten Babbitt material onto the surface of a rotating part to be coated. This type of application process can be difficult to control, unpredictable, time consuming, costly, and requires special fixturing and equipment to manage the parts. The substrate of the bearing typically must be heated, and the shape of the component to which the material is being applied can be a limiting variable, and the pot of molten Babbitt material is typically large which can result in phase separation of the components of the Babbitt material, and waste may become a factor.

Thermal spray techniques for application of Babbitt material may be employed which use a flame generated by an electric arc or fuel and oxygen. In these techniques, similar to the spun Babbitt approach, the part must be heated to achieve a good bond between the Babbitt material and the underlying bearing substrate, but the particle or droplet temperature may be difficult to control, the Babbitt material can readily become degraded by oxygen, moisture, and other contaminants during application, and this occurrence can result in weak oxides layers formed in between layers of the deposited Babbitt material. These weak layer interfaces can increase the wear rate of the Babbitt material applied by thermal spraying as compared to material applied by spun Babbitt techniques. An advantage of thermal spray application is that phase separation in the Babbitt material can be more closely controlled because the volume of molten material heated for application is typically much lower.

Application of Babbitt materials may also be utilized in repair of the component due to wear of the soft protective Babbitt material from the surface, and application processes similar to the initial application may be utilized for repair. When utilizing spun Babbitt application techniques, stripping of the previously applied Babbitt material is required and all of the limitations of the spun Babbitt application process will be present. When utilizing thermal spray application techniques, applying new Babbitt material onto existing Babbitt material is possible, but the quality of the new Babbitt material application is likely to be limited by the quality and condition of the existing Babbitt material on the component.

### SUMMARY

In one aspect, the present disclosure relates to a powder spray applicator system for applying a powder to a surface utilizing a gas stream. The applicator system may include an applicator device which is configured to eject particles of powder in a stream of a heated gas and may have a flow chamber. The applicator device may define a particle path along which particles of the powder stream move upon introduction into the flow chamber and a gas path along which a primary gas stream moves upon introduction into the flow chamber. The applicator device may comprise a body assembly which defines an outer annular gap forming a first section of the gas path and an inner annular gap forming a second section of the gas path. The applicator device may further comprise a spray nozzle which defines a flow passage extending between an entry opening of the spray nozzle and an exit opening of the spray nozzle, and the flow passage may have an initial section and a final section. In embodiments, the initial section of the flow passage may have a converging shape and the final section of the flow passage may have a straight shape. The body assembly and the spray nozzle may be configured to define a convergence point of the particle path and the gas path that is located proximate to the entry opening of the spray nozzle.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings.

The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of an applicator device of a new system for applying Babbitt materials and the like, according to the present disclosure.

FIG. 2 is a schematic sectional view of the applicator device of the system, according to an illustrative embodiment.

FIG. 3 is a schematic sectional view of the applicator device of the system, according to an illustrative embodiment.

FIG. 4 is a schematic and large sectional view of the spray nozzle of the applicator device of the system, according to an illustrative embodiment.

FIG. 5 is a schematic perspective sectional view of the applicator device of the system, according to an illustrative embodiment.

FIG. 6 is a schematic diagram of the system for applying Babbitt materials and the like, according to an illustrative embodiment.

### DETAILED DESCRIPTION

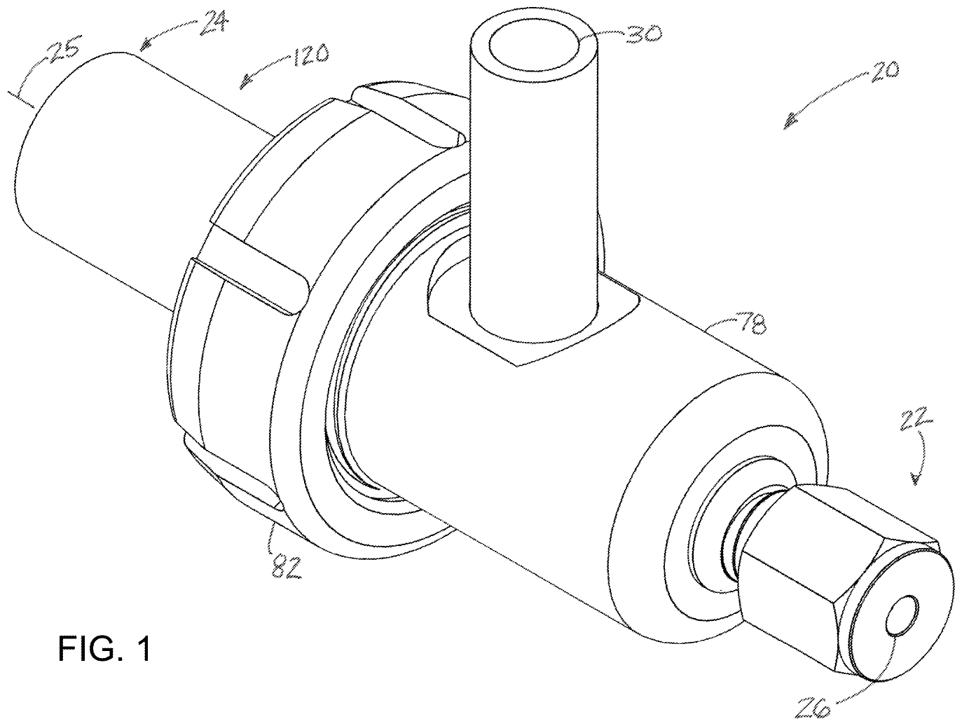

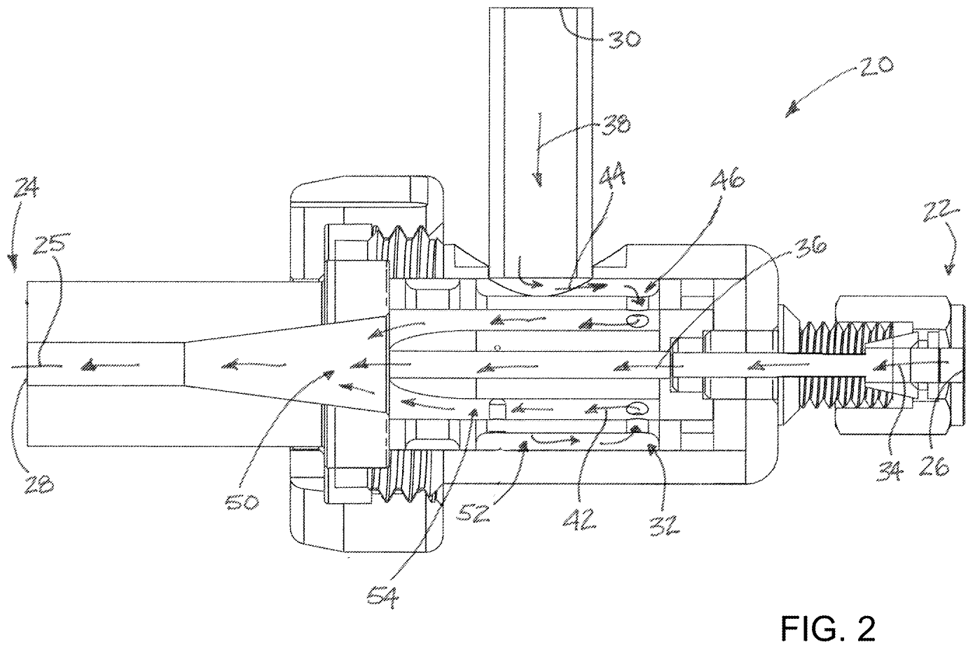

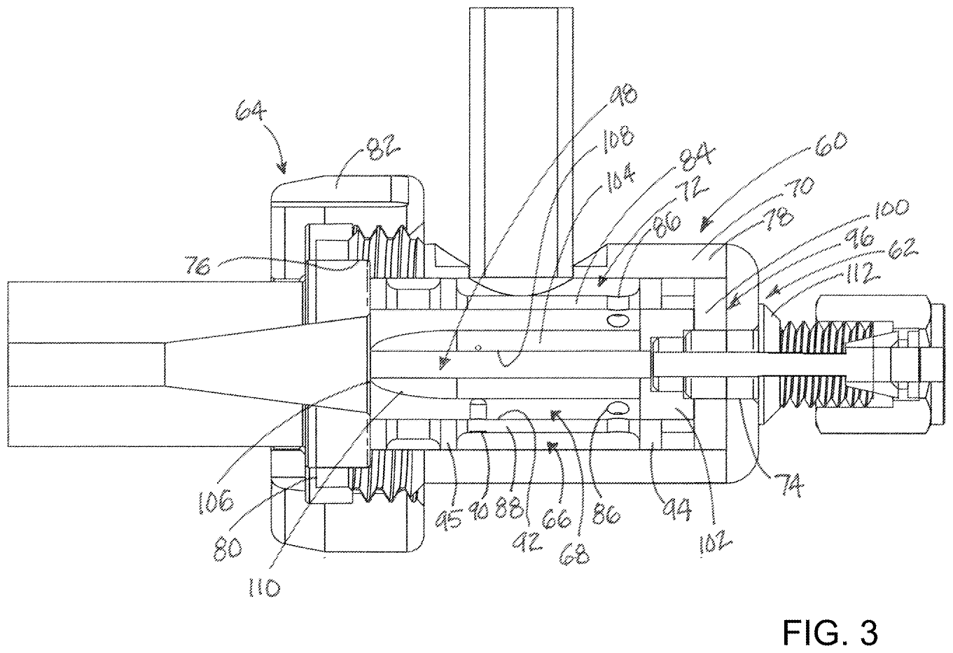

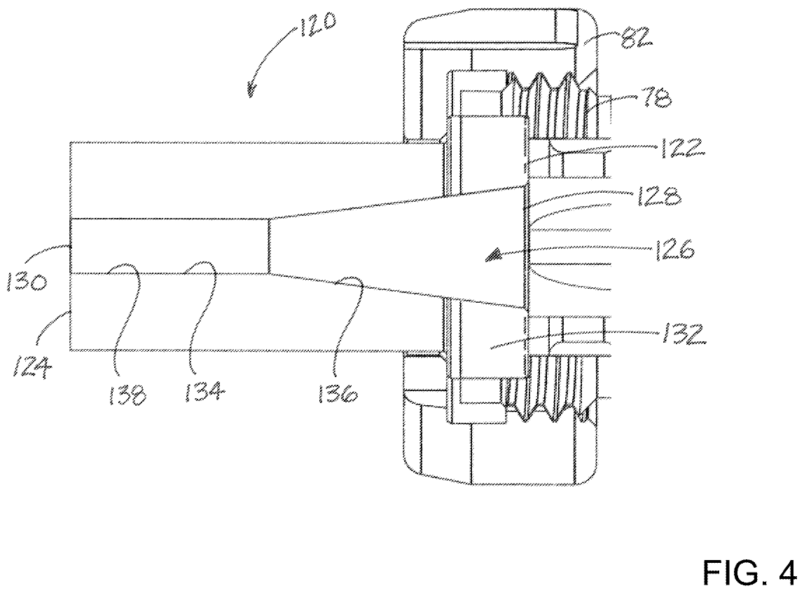

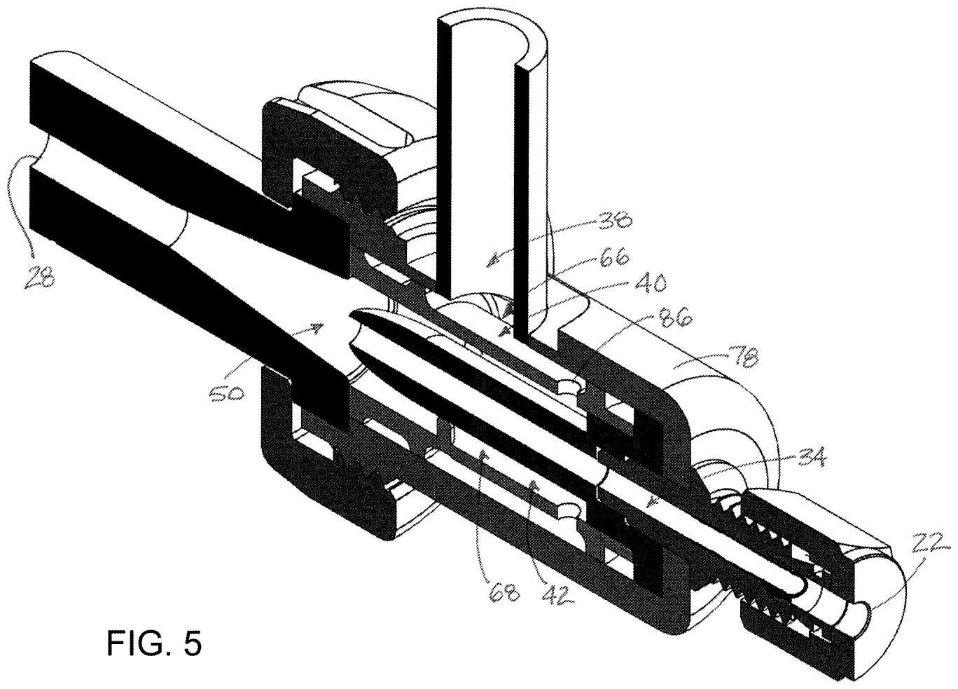

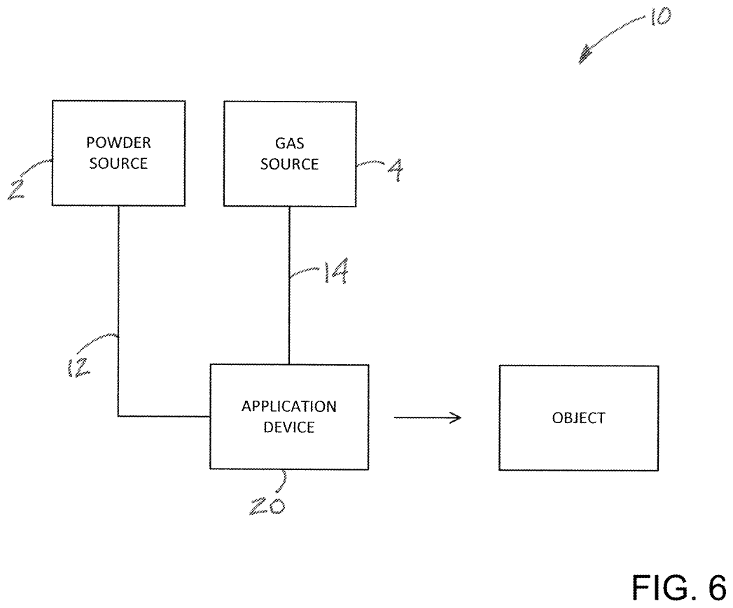

With reference now to the drawings, and in particular to FIGS. 1 through 6 thereof, a new system and apparatus for applying Babbitt materials and the like embodying the principles and concepts of the disclosed subject matter will be described.

The applicants have recognized that techniques such as cold spray deposition are highly useful for deposition of all manner of powdered metals onto surfaces for building thin layers of material and producing coatings or entire part, but conventional cold spray application techniques have some limitations with respect to some metals, polymers, and other low strength and low temperature materials. The limitations of cold spray application techniques may make deposition of materials having those characteristics difficult.

The applicants have also recognized that conventional cold spray nozzle designs utilize a very long converging-diverging supersonic nozzle suitable to accelerate the powdered materials to a very high velocity. The long diverging section inherent to all cold spray nozzle designs can put additional limitations on the suitability of the cold spray equipment to particular component geometries. For example, when applying the Babbitt material to an inward facing cylindrical surface, which is a geometry often encountered in the application of Babbitt materials, the relative size of the nozzle of the cold spray deposition equipment can limit the utilization of this technique on parts with smaller inner diameters of the inward facing cylindrical surface.

For such applications, one approach has been to orient the cold spray nozzle at a low angle relative to the surface and position the spray apparatus outside the curvature of the deposition surface to deposit the cold spray material. However, due to the low shear strength of the alloy of the Babbitt material, it is very difficult if not impossible to spray at very shallow angles and get deposition of the material in an appreciable thickness. Further, attempting to achieve high particle temperatures in order to improve the quality of the deposited Babbitt material is extremely difficult and in most cases impossible due to the cooling of the material particles that occurs in the diverging section of the nozzle passage.

The applicants have developed an apparatus, and an application technique for applying Babbitt materials using the apparatus, which has a unique design that may be utilized in combination with elements of a cold spray system but does not in itself employ a cold spray deposition process as may be commonly understood. The apparatus and its use may be suitable for applying Babbitt material to the surface of a part or component initially, prior to use, as well as subsequent application of the Babbitt material to the part for the purposes of repair.

While the description of the disclosure relates generally to the application of a Babbitt material typically characterized by having a low strength and low melting point, the apparatus and its usage is not necessarily limited to the application of Babbitt materials and, for example, may be utilized to spray and apply materials such as pure tin, antimony, lead, Indium or other materials, even polymers, that could be similarly characterized as having low strength and melting point but may benefit from having a controlled elevated temperature during deposition of the material.

As such, the disclosure addresses the need for an apparatus suitable for creating a high-quality deposition of powdered low temperature, low yield strength materials such as Babbitt materials. Advantageously, the disclosure relates to an applicator apparatus with a nozzle that can be adapted to use with a cold spray deposition system to provide a controlled particle velocity and temperature for achieving high quality surface coatings.

As a further advantage, the applicator device may feature a reduced profile length in a longitudinal direction of the device. In embodiments, the applicator device may utilize a nozzle with a reduced nozzle length to facilitate the application of the sprayed material to form a coating on surfaces having relatively smaller internal diameters than otherwise possible with cold spray deposition apparatus. The relatively reduced nozzle length, and applicator device size, facilitates the movement of the device into areas of limited space, such as smaller bores and semi-cylindrical surfaces which may be found on the internals of bearings of various sizes.

In some embodiments of the disclosure, the geometric configuration of the flow passage of the spray nozzle has a converging section and a straight section, which may produce subsonic gas and particle flow out of the nozzle. The straight section may maintain a subsonic gas velocity, but may moderately accelerate the powder velocity while maintaining particle temperature. In contrast, a cold spray deposition nozzle has a converging section and a diverging section, which may accelerate the gasses to supersonic velocities and produce significant cooling of the particles of powder in the stream. This cooling typically reduces the particle temperature significantly (even to a point below room temperature under certain conditions), and this cooling of the particles can greatly hamper the proper consolidation of certain materials, such as Babbitt materials.

A still further advantage of disclosure is that the applicator device may maintain the separation of streams of the gas and the powder until the streams are close to the nozzle, and illustratively have entered (or just prior to entry into) the converging section of the nozzle. The location of injection of the powder stream into the gas stream may be variable and adjustable to permit adjustment of the heating time of the powder as the particles of powder pass through the nozzle.

In some embodiments, to facilitate the reduction of the overall length of the applicator device and permit the device to apply a coating to surfaces of confined spaces, the applicator device may be configured such that the stream of hot gas enters the device in a radial orientation to the primary longitudinal axis of the device, and may further be configured such that the stream of hot gas enters the device a central or medial location of the applicator device. The configuration of the applicator device may be such that the hot gas entering the device initially moves in a direction away from the nozzle in an axial or longitudinal direction, which may be a direction opposite of the stream of particles of powder. The direction of movement of the hot gas stream may be turned and substantially reversed such of the hot gas stream flows in a longitudinal direction that is opposite to the initial movement of the hot gas stream upon entering the applicator device.

Advantageously, aspects of the disclosure may minimize the opportunity of the particles of the powder to become excessively heated prior to reaching the throat of the spray nozzle, which may result in excessive wear and fouling occurring on the surfaces of the converging section of the nozzle, while permitting the powder particles to heat in the final section of the nozzle prior to exiting the nozzle and impinging on the substrate.

The separation of the gas and particle streams prior to convergence of the streams by the configuration of the applicator device may facilitate maintaining the particles of the powder stream (and any auxiliary gas stream) at relatively cooler temperatures at an initial section of the particle path prior to converging with the heated gas stream. Further, elements of the applicator device may be formed of thermally insulating materials to further thermally isolate the particles of the powder stream from the stream of heated gas, such that heating of the particles by the heated gas only occurs to any significant degree when the gas stream and the particle stream converge. These characteristics of the applicator device may significantly limit or eliminate any melting or significant softening of the particles of the powder stream in the applicator device.

In one aspect, the disclosure relates to a powder spray applicator system 10 suitable for applying a powder to a surface utilizing a gas stream for the purpose of, for example, creating a coating or layer of particles of the powder on the surface. In at least some applications of the system, the gas stream may be heated to a temperature above environmental conditions, such as room temperature.

In greater detail, the applicator system 10 may broadly include a first conduit 12 which is configured to convey particles of the powder. The first conduit may be in communication with a powder source 2 to provide a powder stream comprising particles of the powder and may also comprise an auxiliary gas stream carrying particles of the powder. The particles of powder of the powder stream may have various characteristics, such as being a metal of a relatively low melting point, and may comprise a Babbitt material. Optionally, in implementations of the disclosure, the particles of powder may comprise a low temperature polymer.

The system 10 may further include a second conduit 14 configured to convey a primary gas stream. The second conduit 14 may be in communication with a gas source 4, and gas of the primary gas stream may be heated in any suitable manner.

The applicator system 10 may include an applicator device 20, either alone or in combination with other elements of the system such as the conduit, which is configured to eject particles of the powder drawn from the first conduit 12 in gas of the primary gas stream carried by the second conduit 14. The applicator device 20 may be configured to communicate with the first conduit 12 to receive particles of the powder stream from the conduit 12, and may also be configured to communicate with the second conduit 14 to receive gas of the primary gas stream from the conduit 14.

In illustrative embodiments of the disclosure, the applicator device 20 has an input end 22 and an output end 24, and may have a central longitudinal axis 25 extending in a longitudinal direction of the applicator device between the input 22 and output 24 ends. Illustratively, the applicator device 20 may be generally tubular in character to pass particles of the particles stream from the first conduit 12 from the input end 22 to the output end 24. The applicator device 20 may also have a first input opening 26 located toward the input end 22 and an output opening 28 located toward the output end 24. The first input opening 26 may be configured to connect to the first conduit 12 and receive particles of the particle stream from the first conduit 12, and the output opening 28 may be configured to output the gas of the primary gas stream and the particles of the powder stream (as well as any auxiliary gas stream carrying the powder).

In embodiments, the applicator device 20 may also have a second input opening 30 which may receive the primary gas stream from the second conduit 14. The second input opening 30 may be located on the device 20 between the first input opening 26 and the output opening 28, and may be located medially between the first input and output openings.

The applicator device 20 may define a flow chamber 32 in the device. The flow chamber may have a particle path 34 along which particles of the powder stream move upon introduction into the flow chamber through the first input opening. The particle path 34 is in fluid communication with the first input opening 26 and the output opening 28, and the particle path may extend through a portion of the flow chamber from the input opening to the output opening. The particle path 34 may have a primary flow direction 36 which extends from the input end 22 toward the output end 24, and the particle path may extend generally along the central longitudinal axis 25 of the applicator device.

In embodiments, the applicator device 20 may have a gas path 38 along which the gas of the primary gas stream drawn from the second conduit 14 may move upon introduction into the flow chamber 32 via the second input opening 30. The gas path 38 may extend from the second input opening 30 to the output opening 28 as defined in the flow chamber 32. In some preferred embodiments, the gas path may be convoluted in character, and illustratively may include a first section 40 and a second section 42. The direction of movement of the gas along the gas path 38 may reverse between the first 40 and second 42 sections of the gas path. The direction of movement of the gas of the gas path 38 along the first section 40 may be in a secondary movement direction 44, and the secondary movement direction may be oriented and directed substantially opposite of the primary flow direction 36. The first section 40 of the gas path may extend from the second input opening 30 toward the first input opening 26, and may extend from the secondary input opening to a reversal location 46. The second section 42 of the gas path 38 may extend from the reversal location 46 toward the output opening 28, generally in the primary flow direction 36.

The gas path 38 may be in communication with the particle path 34 at a convergence point 50 of the flow chamber 32. The particle path 34 and gas path 38 may converge at the convergence point 50 to combine the particles of the particle stream moving along the particle path 34 and the gas of the primary gas stream moving along the gas path 38. Illustratively, the convergence point 50 may be located on the central longitudinal axis 25 of the applicator device 20. It will be recognized that the convergence point 50 typically extends to an area or space larger than a single point as the annular flow of gas in the gas stream converges with the relatively linear flow of particles in the particle stream.

The flow chamber 32 may include an initial gas movement space 52 and a subsequent gas movement space 54, and the initial gas movement space may define the first section 40 of the gas path while the subsequent gas movement space 54 may define the second section 42 of the gas path. In some embodiments, the initial gas movement space 52 is annular in shape and the subsequent gas movement space 54 is also annular in shape. In such embodiments, the subsequent gas movement space 54 may be positioned radially inwardly from the initial gas movement space 52 so that the movement space 52 extends about the movement space 54.

The applicator device 20 may include a body assembly 60 which has a first end 62 located toward the input end 22 of the applicator device and a second end 64 located toward the output end 24. The body assembly 60 may define an outer annular gap 66 and an inner annular gap 68. The outer annular gap 66 may define the first section 40 of the gas path 38 and the inner annular gap 68 may define the second section 42 of the gas path.

The body assembly 60 of the applicator device may include a housing structure 70 which may define a housing interior 72 and may at least partially define the flow chamber 32. The housing structure 70 may have a first opening 74 which is located at the first end 62 of the housing structure and a second opening 76 which is located at the second end 64 of the housing structure. The housing structure 70 may comprise a case portion 78 which encloses a substantial portion of the housing interior 72. The case portion 78 may extend from the first end 62 of the body assembly toward the second end 64 of the body assembly. The case portion 78 may be open toward the second end of the housing structure and may be substantially closed toward the first end. The case portion 78 may have the first opening 74 of the housing and an aperture 80 at the second end 64 of the case portion. In the illustrative embodiments, exterior threads may be formed on the case portion toward the second end 64.

The housing structure 70 may further comprise a cap portion 82 which may have the second opening 76 of the housing structure. The cap portion 82 may cover and may close the aperture 80 of the case portion at the second end of the housing structure. A portion of the case portion 78 may be received in the cap portion 82. The cap portion 82 may have interior threads for engaging the exterior threads formed on the case portion to mount the cap portion on the case portion, such as in a removable manner.

The body assembly 60 of the device 20 may further include an outer body structure 84 which may be positioned in the housing structure 70, and the structure 84 may be positioned in the housing interior 72. The outer annular gap 66 of the body assembly may be formed between the outer body structure 84 and the housing structure 70. A plurality of holes 86 may be formed in the outer body structure 84 to permit communication between the outer 66 an inner 68 annular gaps of the body assembly, and the holes 86 may be located at the reversal location 46 of the gas path 38 between the first 40 and second 42 sections of the gas path. The plurality of holes 86 may form a location in the flow chamber in which the primary gas stream is distributed about the circumference of the inner annular gap 68.

In greater detail, the illustrative embodiments of the outer body structure 84 may include a perimeter wall 88 which is tubular in character and substantially circumferentially continuous. The perimeter wall 88 may has an outward surface 90 and an inward surface 92. Illustratively, the inward surface 92 may be substantially cylindrical in shape. The plurality of holes 86 of the outer body structure may be formed in the perimeter wall 88 and extend between the outward 90 and inward 92 surfaces of the perimeter wall. The plurality of holes 86 may be positioned along the circumference of the perimeter wall, and may be substantially equally spaced along the circumference of the perimeter wall to facilitate a more even distribution of the gas stream about the circumference.

The outer body structure 84 may also include at least one spacing protrusions 94 which extends outwardly from the perimeter wall 88 to space the outward surface 90 of the wall 88 from the housing structure 70. The spacing protrusion 94 may produce the outer annular gap 66 between the outward surface 90 of the wall 88 and the case portion 78 of the housing structure. The spacing protrusion 94 may protrude with respect to the outward surface, and may comprise an annular rib which extends substantially continuously about the circumference of the wall 88. In some embodiments, a plurality of the spacing protrusions 94 may be utilized. Of the plural spacing protrusions, a first spacing protrusion 94 may be located toward the first end 62 of the body assembly and a second spacing protrusion 95 may be located toward the second end of the body assembly. The first section 40 of the gas path 38 may be defined between the first 94 and second 95 spacing protrusions.

The body assembly 60 of the device 20 may also include an inner body structure 96 which may define a channel 98, and the channel a form a portion of the particle path 34. The inner body structure 96 may be positioned in the housing structure 70, and the outer body structure. The inner body structure 96 may extend from the first end 62 of the body assembly toward the second end 64 of the assembly. The outer body structure 84 may function to provide a degree of protection to the inner body structure 96 from direct exposure to the heat of the heated gas moving into the housing structure 70 at the second input opening 30.

In greater detail, the illustrative embodiments of the inner body structure 96 include a base flange portion 100 located toward the first end 62 of the body assembly, and the base flange portion may be positioned between an end of the outer body structure 84 and the case portion 78 of the housing structure. The base flange portion 100 may space the perimeter wall 88 of the outer body structure from the case portion of the housing structure. The inner body structure 96 also includes an intermediate insert portion 102 which may be at least partially inserted into the outer body structure 84. The intermediate insert portion 102 may engage the inward surface 92 of the perimeter wall, and may be located adjacent to the base flange portion 100. The intermediate insert portion 102 may close an end of the perimeter wall 88 of the outer body structure.

The inner body structure 96 of the body assembly 60 may further include a guide portion 104 which may extend from the intermediate insert portion 102 toward the second end 64 of the body assembly. The guide portion 104 may terminate at a tip 106. The guide portion 104 may have an inner channel surface 108 and an outer guide surface 110. The inner channel surface 108 may define a portion of the channel 98 of the inner body structure. The inner channel surface 108 may form a portion of the particle path 34. The outer guide surface 110 may define a portion of the second section 42 of the gas path.

In some illustrative embodiments, the inner channel surface 108 may have a substantially uniform diameter along the length of the surface, and the outer guide surface 110 may have a transverse diameter dimension, and the transverse diameter dimension may decrease toward the second end 64 of the body assembly and toward the tip 106 of the guide portion such that the particle path 34 and the gas path 38 converge. Optionally, the longitudinal length of the guide portion 104 may be varied, such as by interchanging guide portions of different lengths, to provide a variety of different locations of the convergence point 50 between the particle and gas path and thereby permitting adjustment of the time that the particles of powder are exposed to the heated gas and the degree to which the particles are heated by the gas.

In embodiments of the guide portion 104, one or more of the surfaces 108, 110 may have a low friction characteristic, and may be constructed of a suitable low friction material or a low friction surface material may be formed on the one or more surfaces. In some embodiments, the guide portion 104 may be formed of or include a material having relatively low thermal conductivity to help minimize thermal transfer from the outer guide surface 110 to the inner channel surface 108, thus minimizing thermal transfer from gas moving along the gas path 38 to particles moving along the particle path 34 until the paths converge at the convergence point 50.

The body assembly 60 may include a fitting portion 112 for connecting to the first conduit 12, and which may be positioned on the first end 62 of the body assembly. The fitting portion 112 may define a portion of the article path 34. A part of the fitting portion 112 may extend through the first opening 74 of the housing structure, and a part of the fitting portion may extend into the base flange portion 100 of the inner body structure.

The applicator device 20 may further include a spray nozzle 120 which may have an entry end 122 and an exit end 124. The spray nozzle 120 may define a flow passage 126 extending between an entry opening 128 at the entry end 122 and an exit opening 130 at the exit end 124 of the spray nozzle. The flow passage 126 may form a continuation portion of the particle path 34, and may extend along a passage longitudinal axis which may be oriented substantially parallel to the longitudinal axis 25 of the applicator device. The entry opening 128 of the spray nozzle may be positioned adjacent to the tip 106 of the guide portion of the inner body structure. The flow passage 126 may also form a continuation portion of the gas path 38.

The entry end 122 of the spray nozzle may be positioned adjacent to the second end 62 of the body assembly. Illustratively, the spray nozzle 120 may have a perimeter flange 132 that is positioned toward the entry end 122 of the nozzle. The perimeter flange 132 may be engaged by the cap portion 82 of the housing structure, and the flange may be captured by the cap portion such that the spray nozzle 120 extends through the second opening 76 of the housing structure.

The flow passage 126 may be defined by a passage surface 134 which extends about the flow passage and may extend between the entry end 122 and the exit end 124 of the spray nozzle. The passage surface 134 may extend from the entry opening 128 to the exit opening 130 of spray nozzle. The flow passage has an initial section 136 extending from the entry end 122 toward the exit end 124 of the spray nozzle. The flow passage 126 has a final section 138 extending from the exit end 124 toward the entry end 122 of the spray nozzle. The passage surface 134 of the initial section may have a converging shape, and the passage surface of the final section may have a straight shape. The flow passage 126 may have a diameter which is measured perpendicular to the longitudinal axis 25 of the flow passage. The diameter of the flow passage may decrease in magnitude from the entry end of the spray nozzle toward the final section 138 of the flow passage, and the diameter the flow passage may have a substantially uniform magnitude from the exit end 124 of the spray nozzle toward the initial section 136 of the flow passage. The configuration of the final section 138 may enhance the spreading of the plume of powder particles.

The flow passage 126 may have an overall length between the entry and exit openings of the spray nozzle. The initial section 136 of the flow passage may have a first length and the final section 138 of the flow passage may have a second length. In some embodiments, the first length of the initial section 136 is greater than the second length of the final section 138. Optionally, in some embodiments, the flow passage 126 of the nozzle 120 may only include the initial section 136 with converging shape, but not the final section 138 with a uniform diameter.

In some implementations of the disclosure, it is advantageous to spray a Babbitt material at a temperature near the melting point of the material to enhance bonding between the particles of the powder and the substrate on which the material is being applied. For the most suitable spray application of particles of the Babbitt material at temperatures close to or at the melting point temperature of the material, it may be beneficial to construct one or more elements of the applicator device from a material resistant to fouling by the material forming the particles of the powder, such as materials having a low friction or low adhesion surface relative to the Babbitt material, like a plastic or a ceramic material. Elements of the applicator device 20 which may be constructed from such materials may include the spray nozzle 120 and the inner body structure 96. Other elements of the spray applicator 20 may be formed from materials that resist being damaged by oxidation, corrosion, or mechanical loading at suitably high pressures and operating temperature utilized for the spray application operation. For example, stainless steels, such as 316L, may be employed for forming these components.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

Further, those skilled in the art will appreciate that steps set forth in the description and/or shown in the drawing figures may be altered in a variety of ways. For example, the order of the steps may be rearranged, substeps may be performed in parallel, shown steps may be omitted, or other steps may be included, etc.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A powder spray applicator system for applying a powder to a surface utilizing a gas stream, the applicator system comprising
an applicator device configured to eject particles of powder in a stream of a heated gas, the applicator device having a flow chamber, the applicator device defining a particle path along which particles of the powder stream move upon introduction into the flow chamber, the applicator device defining a gas path along which a primary gas stream moves upon introduction into the flow chamber, the applicator device comprising:
a body assembly defining an outer annular gap forming a first section of the gas path and an inner annular gap forming a second section of the gas path; and
a spray nozzle defining a flow passage extending between an entry opening of the spray nozzle and an exit opening of the spray nozzle, the flow passage having an initial section and a final section,
wherein the initial section of the flow passage has a converging shape and the final section of the flow passage has a straight shape; and
wherein the body assembly and the spray nozzle are configured to define a convergence point of the particle path and the gas path located proximate to the entry opening of the spray nozzle.

2. The system of claim 1 wherein the final section of the flow passage is configured to produce a gas stream of subsonic character.

3. The system of claim 2 wherein the flow passage of the spray nozzle has a passage surface, the passage surface of the initial section of the flow passage has a substantially conical shape; and
wherein the passage surface of the final section of the flow passage has a substantially cylindrical shape.

4. The system of claim 1 wherein the applicator device has an input end and an output end with a central longitudinal axis extending in a longitudinal direction of the mixing device between the input and output ends, the applicator device having a first input opening at the input end and an output opening at the output end, the first input opening at the input end being configured to connect to a first conduit to receive particles from a powder source, the output opening being configured to output the primary gas stream and particles of the powder.

5. The system of claim 4 wherein the applicator device has a second input opening located on the body assembly between the first input opening and the output opening, the second input opening being configured to connect to a second conduit to receive the primary gas stream.

6. The system of claim 4 wherein the particle path of the applicator device is in fluid communication with the first input opening and a portion of the particle path is defined by the flow chamber extending from the input opening toward the output opening, the particle path having a primary flow direction extending from the input end toward the output end.

7. The system of claim 6 wherein the gas path of the applicator device is in communication with the second input opening and a portion of the gas path is defined in the flow chamber, the gas path extending from the second input opening to the output opening, the gas path having a convoluted character.

8. The system of claim 7 wherein the gas path has a first section and a second section, a direction of movement of the gas along the gas path reversing between the first section in the second section of the gas path.

9. The system of claim 8 wherein, the direction of movement of gas along the first section of the gas path is in a secondary movement direction, the secondary movement direction being substantially opposite of the primary flow direction.

10. The system of claim 9 wherein the first section of the gas path extends from the second input opening extending from the secondary input opening to a reversal location, the second section of the gas path extending from the reversal location toward the output opening of the applicator device.

11. The system of claim 1 wherein the gas path is in communication with the particle path at a convergence point of the flow chamber to combine the primary gas stream and particles of the powder in the powder stream, the convergence point being located at the entry opening of the spray nozzle.

12. The system of claim 11 wherein the convergence point of the flow chamber is located in the initial section of the flow passage of the spray nozzle having the converging shape.

13. The system of claim 8 wherein the flow chamber includes an initial gas movement space of the flow chamber defining the first section of the gas path and a subsequent gas movement space of the flow chamber defining the second section of the gas path, the initial gas movement space and the subsequent gas movement space being annular in shape.

14. The system of claim 13 wherein the subsequent gas movement space is positioned radially inwardly from the initial gas movement space.

15. The system of claim 1 wherein the body assembly of the applicator device includes a housing structure defining a housing interior and having a case portion and a cap portion removably mounted on the case portion, the cap portion being configured to secure the spray nozzle on the body assembly when the cap portion is mounted on the case portion.

16. The system of claim 15 wherein the body assembly further includes an outer body structure positioned in the housing interior of the housing structure, an outer annular gap of the body assembly being formed between the outer body structure and the housing structure, an inner annular gap of the body assembly being formed in the outer body structure, a plurality of holes being formed in the outer body structure to permit fluid communication between the outer annular gap and the inner annular.

17. The system of claim 16 wherein the body assembly further includes an inner body structure defining a channel forming a portion of the particle path, the inner body structure being positioned in the outer body structure to further define the inner annular gap.
